(19) United States
(12) Patent Application Publication
(10) Pub. No.: US 2021/0196097 A1
(43) Pub. Date: Jul. 1, 2021

(54) UNIVERSAL HANDHELD GRIP FOR CLEANING

(71) Applicants: Wayne Fromm, Toronto (CA); Sage Fromm, Toronto (CA)

(72) Inventors: Wayne Fromm, Toronto (CA); Sage Fromm, Toronto (CA)

(21) Appl. No.: 17/103,926

(22) Filed: Nov. 24, 2020

Related U.S. Application Data
(63) Continuation-in-part of application No. 16/732,287, filed on Dec. 31, 2019.

(51) Int. Cl. A47L 13/46; A47L 13/16; B08B 1/00

(52) U.S. Cl. CPC A47L 13/46; B08B 1/001; A47L 13/16

(57) ABSTRACT

A cleaning tool having a multi-functional lower surface for attaching a variety of cleaning fabrics and absorbent sheets, including fabric towels and paper towels. The cleaning device includes a connecting portion for engaging an elongate handle. The connecting portion is rotatable, such that cleaning device may rotate at a connection between the cleaning portion and the handle. The connecting portion rotates such that a gripping portion is capable of clasping the cleaning sheet for hands-free removal and disposal.

### CROSS REFERENCE TO RELATED APPLICATIONS

This application is a continuation-in-part of U.S. patent application Ser. No. 16/732,287, filed Dec. 31, 2019. The above application is incorporated by reference herein.

### FIELD

This disclosure relates generally to tools for cleaning surfaces such as counters, mirrors, windows, floors, walls, ceilings, and furniture surfaces and, more specifically, to a cleaning tool having removable cleaning materials.

### BACKGROUND

Surfaces such as counters and floors often require cleaning to be free of dirt or debris. Surfaces may become soiled rapidly due to environmental contaminants such as dust and due to the deposit of dirt and debris and liquids by people, machines, and pets. Repeated cleaning is often necessary, and cleaning may require skin exposure to such environmental contaminants and cleaning chemicals on the hands of the person responsible for cleaning. Numerous devices and methods have been developed for returning a surface to a clean and dry condition. Sweeping or vacuuming is useful for removing loose dirt and debris, and mopping works well for removing liquids and certain debris from large surfaces such as floors.

Further, it is often not necessary to thoroughly clean an entire surface to return it to a clean condition. For example, a small spill or localized deposit of dirt and debris does not necessitate a vacuuming or mopping of the entire floor. The act of preparing and using a vacuum cleaner or mop for a small area is time consuming. Alternatively, a person may take a towel or disposable cleaning sheets such as a paper towel and clean the localized area. One advantage of a vacuum cleaners and mops are that they do not require contact of chemicals or contaminants with the skin during cleaning, which may cause irritation.

Another example of a light cleaning job is where the homeowner wishes to remove a light coating of dust or debris from a window or mirror. Use of a bucket and sponge or rag is unnecessarily involved since what is really needed is a light cleaning of the surface. A homeowner may wish to just return the surface to its optimal appearance without unnecessary steps. Therefore, there is a need for a simple device to quickly and easily clean a variety of surfaces. Antimicrobial cleaning products are well known in the art and in wide use. It is to be understood that cleaning solutions are known to include antibacterial, antiviral and other agents that kill organisms that may be harmful to human health. It is to be understood that such antimicrobial, disinfecting solutions can be used with cleaning devices known in the prior art and cleaning devices disclosed herein.

Smaller areas often require cleaning where mopping and vacuuming are impractical. For such smaller spills, scrubbing and the use of strong chemicals may be the most practical and efficient solution. Scrubbing often requires gripping, by a hand, of and absorbent material such as a paper towel, sponge, or rag. The absorbent material is then contacted with the material to be removed, and potentially a cleaning chemical. Here, the skin of the hand may also come into contact with the material to be cleaned and a cleaning chemical, potentially leading to irritation. Further, the use of gloves during scrubbing may irritate skin due to allergens in the glove material, such as latex, and there may be discomfort caused by having a rubber material in contact with the skin.

Therefore, there is a need for a cleaning tool that allows for the cleaning of small areas without the need for a vacuum or mop, while avoiding chemical irritation of the skin, or the need to use gloves, for a person cleaning.

### SUMMARY

The device and method of the present disclosure includes a hand held cleaning tool having a multi-functional, generally planar, lower surface for attaching a variety of cleaning fabrics and absorbent sheets, including fabric towels and paper towels. In one embodiment, the hand held grip has an upper portion that is molded and contoured to fit a hand, where the upper portion may be comprised of a soft foam for easy gripping. The lower portion may be comprised of a hard, rectangular plate, having sharp corners for cleaning hard to reach areas. The lower surface of the plastic block may include both a hook portion of a hook and loop fastener and an adhesive paper sheet or adhesive gel portion. The adhesive may be a reusable adhesive configured to bind and release a paper towel repeatedly.

According to a method of the present disclosure, the adhesive is configured to bind a cleaning sheet, which may be a paper towel, prior to application of the paper towel to a liquid, such that the bond formed between the paper towel and the adhesive persists even after exposure to a liquid during cleaning, whereas the adhesive would not generally bind a paper towel after it has absorbed a critical amount of liquid.

The adhesive may be a reusable dry adhesive, and may comprise a washable adhesive that allows for reuse after being exposed to a liquid such as water. At least one portion of the lower surface has an adhesive material, such as a washable adhesive, that is capable of binding a paper towel. The lower surface of the cleaning tool may also include a second type of binding material capable of binding a cloth or sponge. The adhesive material may be on a paper surface or may be a gel that directly bind a plastic lower portion of the handle. The adhesive paper may a stack of adhesive paper attached to the lower portion of the handle.

A plurality of adhesive sheets are supported on the midportion of the base layer in a stack configuration. Each of the sheets has an outward face for gripping a cleaning sheet, such as a paper towel, and an opposed inward face for joining the adhesive sheets in the adhesive sheet stack. The outward face of each of the adhesive sheets is configured to contact a cleaning sheet. When the cleaning sheet becomes soiled, the cleaning sheet may be peeled away to expose the adhesive sheet for reuse. In some embodiments of the present disclosure, the cleaning sheets are comprised of a non-woven material, such as paper. The cleaning sheets may be folded such that a first cleaning sheet may be bound by the adhesive sheet on the lower surface of the cleaning tool of the present disclosure.

In one embodiment, the hook portion of the hook and loop fastener is positioned at a perimeter of the lower surface of the plastic block and the adhesive portion is positioned centrally within the hook and loop portion on the lower surface of the plastic block. In one embodiment, the lower surface only includes an adhesive portion, without the hook and loop fastener portion. The second portion of the lower surface that binds a cloth or sponge may be a hook portion of a hook and loop fastener.

Each adhesive sheet in a stack may have a central portion bounded by an outer perimeter, with the outer perimeter having a first edge. The perimeters of the cleaning sheets are bonded to each other, except along the first edge, such that the plurality of adhesive sheets are retained in the stacked configuration.

A mount for storing the cleaning tool is contemplated within the present disclosure. Additionally, means for removing a soiled cleaning material, such as a release mechanism and tools such as tweezers, are included in some embodiments of the present disclosure.

A handle may be attached to the hand grip. The handle may rotate around the hand grip, thereby creating a gripping mechanism for grasping cleaning materials such as a cleaning sheet and providing a hands-free method for cleaning and disposing of cleaning materials. The handle or the hand grip may be hollow and capable of storing and dispensing cleaning solutions.

### BRIEF DESCRIPTION OF THE DRAWINGS

FIG. 1 is a front perspective view of a cleaning tool according to the present disclosure;

FIG. 2 is an exploded view of a cleaning tool according to the present disclosure;

FIG. 3 is a bottom perspective view of a cleaning tool including adhesive sheets according to the present disclosure;

FIGS. 4a and 4b show a side perspective view of the cleaning tool, where FIG. 4a shows the cleaning tool attached to a cleaning sheet and where FIG. 4b shows the cleaning sheet being removed from the cleaning tool with a hand according to the present disclosure;

FIGS. 5a and 5b show a side perspective view of the cleaning tool, where FIG. 5a shows the cleaning tool surrounded by cleaning implements and where FIG. 5b shows the cleaning tool attached to a sponge;

FIG. 6 is a perspective view of the cleaning tool attached to a cleaning cloth according to the present disclosure;

FIG. 7 is a bottom perspective view of a cleaning tool including adhesive gel according to the present disclosure;

FIGS. 8a-8c show an embodiment of the cleaning tool of the present disclosure including a perspective view of a detachable stack of adhesive sheets and a hook fastener surface on a lower portion of the cleaning tool, as shown in FIG. 8a, wherein the upper surface of the detachable stack is shown in FIG. 8b and the lower surface of the detachable stack is shown in FIG. 8c according to the present disclosure;

FIGS. 9a-9c show a perspective view of an embodiment of the present disclosure including a release button, wherein FIG. 9a shows a top perspective view including the release button in a neutral position, FIG. 9b shows a shows a bottom perspective view of the cleaning tool with the release button in a neutral position, and wherein FIG. 9c shows a bottom perspective view of the cleaning tool with the release button in a depressed position according to the present disclosure;

FIGS. 10a and 10b show an embodiment of the present disclosure including a wall mount, wherein FIG. 10a shows the cleaning tool attached to the wall mount, and wherein FIG. 10b shows the wall mount according to the present disclosure;

FIGS. 11a-11d show an embodiment of the present disclosure including a tweezer or a pick, wherein FIG. 11a shows the cleaning tool including a tweezer inserted in a stored position, wherein FIG. 11b shows a tweezer grasping a cleaning sheet, wherein FIG. 11c shows a tweezer adjacent the cleaning tool, and wherein FIG. 11d shows a pick according to the present disclosure;

FIG. 12 shows a top perspective view of a cleaning tool according to the present disclosure;

FIG. 13 shows a front perspective view of a handled cleaning tool in a housing according to the present disclosure;

FIGS. 14a and 14b show a bottom perspective view and a side view of the handled cleaning tool in contact with a cleaning sheet, respectively, according to the present disclosure;

FIGS. 15a and 15b show an open side view of a gripper grasping a cleaning sheet and a closed side view of a gripper grasping a cleaning sheet, respectively, according to the present disclosure;

FIGS. 16a and 16b show a top perspective view of a forked connector and a top perspective view of a forked connector attached to a cleaning tool, respectively, according to the present disclosure;

FIG. 17 shows a bottom perspective view of a handled cleaning tool with an elastic band engaging the hand grip according to the present disclosure;

FIG. 18 shows a side view of a handled cleaning tool including a long handle, according to the present disclosure.

### DETAILED DESCRIPTION

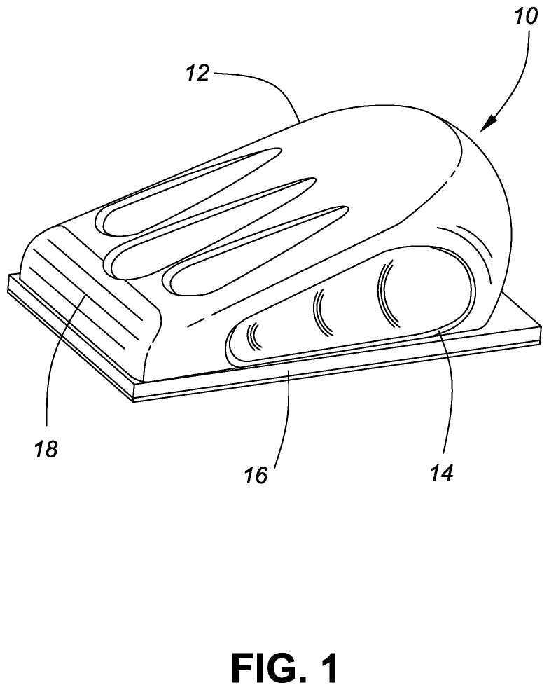

Referring to FIG. 1, in one aspect of the disclosure, a hand grip for a cleaning tool is formed of a flexible material has a constant cross section along its longitudinal axis. The cleaning tool has a flat lower surface and a curved upper portion comprising the hand grip, the curved upper surface having an arc length about equal to the width of the flat lower surface. The width of the curved upper surface is preferably less than the width of the flat lower surface.

Embodiments of the present disclosure are directed toward providing a cleaning tool and a method of using the cleaning tool. Certain details are set forth below to provide a sufficient understanding of the disclosure. However, it will be clear to one skilled in the art that the disclosure may be practiced without these particular details.

Referring to FIG. 1, a cleaning tool 10 may have a hand grip 12 in accordance with an embodiment of the present disclosure that may have a length along the longitudinal direction that is much greater than its width or height perpendicular to the longitudinal direction. In some embodiments, the length of the hand grip 12 along the longitudinal direction is greater than about two times the greatest extent of the hand grip 12 in a direction perpendicular to the longitudinal direction, including the width and height. In one embodiment, the hand grip 12 has a length along the longitudinal direction that is greater than about three times the extent of the cleaning tool 10 in a direction perpendicular to the longitudinal direction. In some embodiments, a longitudinal groove, or finger grip, 14 extends along one or both sides of the cleaning tool 10 parallel to the longitudinal direction to facilitate gripping by a user.

A hand grip 12 of the cleaning tool 10 is curved whereas a lower portion 16 is flat. The lower portion has a width in a direction perpendicular to the longitudinal direction that is greater than a width of the upper surface 16. The narrower width of the upper portion, or hand grip 12 corresponds to the narrowing necessary to cause the curved upper surface to have an arc length 24 about equal to the width of the lower surface. The radius of curvature of the curved hand grip 12 may vary with distance from the center of the cleaning tool 10. The radius of curvature preferably decreases with distance from the center. A front portion 18 of the hand grip 12 may be curved and extend to a point flush with the lower portion 16. Hand grip 12 may be extendable, through a telescopic rod, sliding bracket or other means as would be known to one of ordinary skill in the art, for overhead use and for lower cleanups such as liquid pet mess.

In other embodiments the hand grip 12 may be a handle or other device capable of being used to hold and object during cleaning, as would be known to one of ordinary skill in the art. The hand grip 12 of the cleaning tool 10 may be ergonomically designed to support the elbow and forearm while cleaning. This structure may not only reduce tension from the wrist, cervical vertebrae, shoulder and arm, but also effectively relieves pains from the arm, shoulder and neck muscles as well as localized pressure on the wrist. The cleaning tool 10 may be comprised of strong plastic, or memory foam.

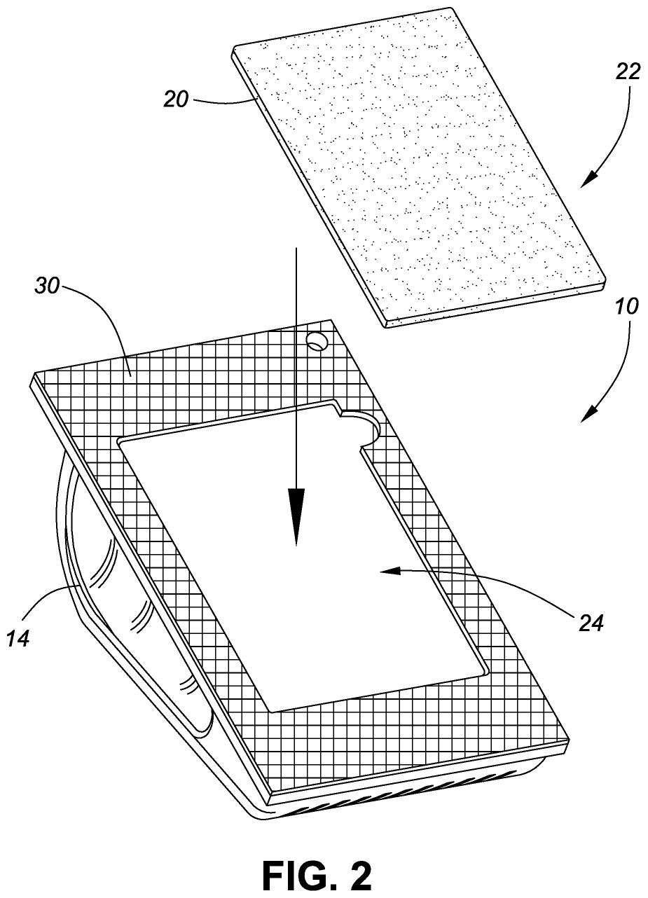

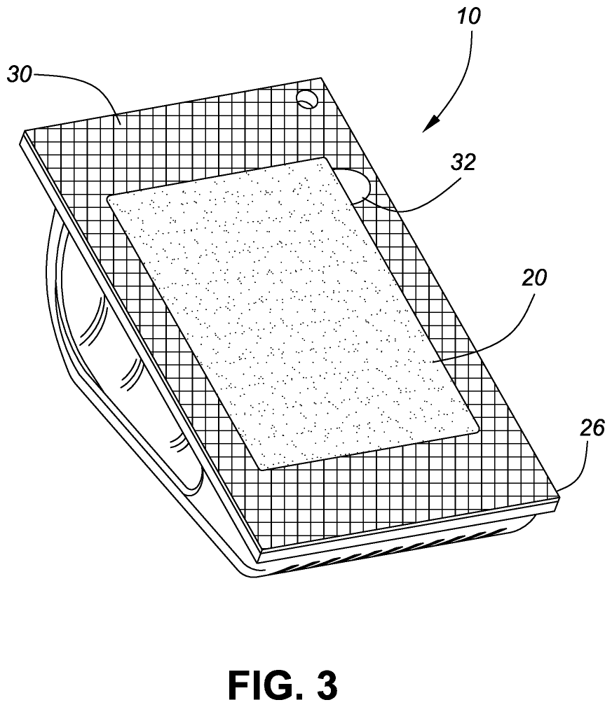

Referring to FIGS. 2 and 3, the lower portion 16 of cleaning tool 10 may, in one embodiment, include an adhesive sheet 20 and a hook fastening portion 30. Adhesive sheet 20 may be part of an adhesive sheet stack 22. Fastening portion 30 may be a hook portion of a hook and loop fastener. In some embodiments, the adhesive portion may cover the entire lower surface of the lower portion 16, such that there is no exposed hook fastener portion 30 included in cleaning tool 10. The hook fastener portion 30 may completely extend around a perimeter of the lower portion 16 and thereby surround adhesive sheet 20, or hook fastener portion 30 strips or sections may be present only on two opposite sides of lower portion 16. In one embodiment, strips or sections of hook fastener portion 30 may be present on 3 sides on the perimeter of lower portion 16. In one embodiment, the adhesive portion may extend to the front portion 18, such that the front portion becomes adhesive and capable of binding a cleaning sheet 40. This embodiment allows for a decreased possibility that cleaning sheet 40, where bound to front portion 18, will become soiled or wet, thereby potentially allowing a user to grip a dry, clean portion of cleaning sheet 40. In this embodiment, cleaning sheet 40 may extend generally vertically up from the lower portion 16, thereby allowing a portion of cleaning sheet 10 to remain dry. Here, cleaning tool 10 may be rolled forward to bind front portion 18 to bind cleaning sheet 40.

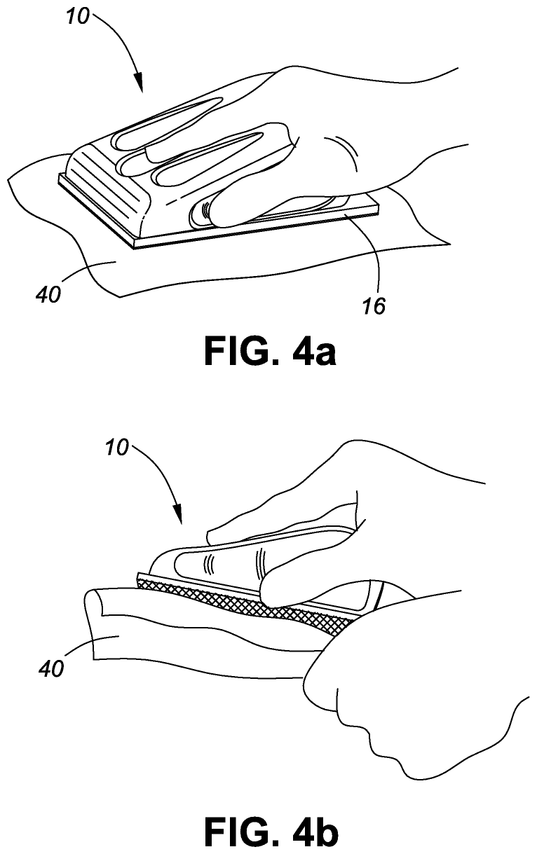

Adhesives according to the present disclosure may include dry adhesives and water-resistant, or washable, adhesives. A typical dry adhesive is reusable and releasable. A dry adhesive is intended to create a nondestructive temporary bond which may be undone and repeated many times without prohibitively degrading its adhesive performance between bond cycles. A dry adhesive must, according to the present disclosure, be capable of generating a bond to cleaning sheet 40 (as shown in FIGS. 4a and 4b) of adequate strength to adhere to at least one wet square of standard paper towel, in what may be referred to as the dry adhesive's “adhesion on” configuration relative to the adhesive's intended target.

A typical size of a manufactured paper towel is a square 11 inches by 11 inches. Some paper towels have perforations to easily divide towels into 11-by-5.5-inch sections. Thus, the strength of the bond between the total surface area of the adhesive sheet 20 contacting cleaning sheet 40 must be of sufficient strength to support a wet paper towel of at least these sizes, as could be determined by one of ordinary skill in the art. The dimensions of the region adhesive sheet that contact cleaning sheet 40 may be adjusted to support a paper towel of a desired size. Cleaning sheet 40 sections may be linked through perforations and multiple sections may be removed at one time and folded prior to adhering to adhesive sheet 20. To support such use, bond area or the adhesive strength of the dry adhesive may be adjusted accordingly.

The strength of an adhesive bond is typically measured either in terms of its load bearing capacity at failure, or in terms of the energy dissipated during the separation of adhesive and adherent. This measured “maximum” adhesive strength of a dry adhesive bond will vary depending on many factors regarding both adhesive and adherend. Nonetheless, dry adhesives are capable of generating adequate strength for low and moderate load situations, as is the case for the present disclosure, particularly when bond area may be increased.

As illustrated in FIG. 2, in one embodiment, an adhesive sheet stack 22 is fitted within stack recess 24. Stack recess 24 may have a depth configured such that the fastening portion 30 surrounds adhesive sheet stack 22 and the outer surface of adhesive sheet stack 22 is slightly recessed, such that the surface of hook portion 30 extends further in a direction distal to hand grip 12 than does the outer surface of adhesive sheet 20. Here, hook fastening portion 30 may be compressed during use in order for a user to contact adhesive sheet 20 with cleaning sheet 40. Stack recess 24 may have a groove 32 for removing adhesive sheet stack 22.

Cleaning sheet 40 may be a conventional paper towel, as would be known to one of ordinary skill in the art. Paper towels may be packaged as a roll of perforated sheets or in stacks of pre-cut and pre-folded layers for use in paper-towel dispensers. Unlike cloth towels, paper towels are disposable and intended to be used only once. Paper towels soak up water because they are loosely woven which enables water to travel between the fibers. Paper towels have similar purposes to conventional towels, such as drying hands, wiping windows and other surfaces, dusting and cleaning up spills. Paper may be made from either virgin or recycled paper pulp which is extracted from wood or fiber crops. Paper towels are sometimes bleached during the production process to lighten the paper's coloration. Resin size may be used to improve the wet strength. Paper towels may be packed individually and sold as stacks, or are held on a continuous roll, and come in two distinct classes: domestic and institutional. Many companies produce paper towels, as would be known to one of ordinary skill in the art.

As shown in FIGS. 4a and 4b, adhesive sheet 20 binds cleaning sheet 40, thereby allowing a user to clean an area without the need for a hand to come into contact with the cleaning sheet 20 or the materials to be cleaned. FIG. 4a shows cleaning sheet 40 attached to cleaning tool 10 after a user has pressed the lower portion 16 of cleaning tool 10 against a paper towel. The user may, in some embodiments, be required to administer sufficient pressure, with a cleaning sheet 40 resting on a flat surface, to compress hook fastener 30 to allow adhesive sheet 40 to contact cleaning sheet 40. Once contacted, a dry cleaning sheet 40, will form a bond with the adhesive, which may be a washable adhesive. The bond may form more readily with a dry cleaning sheet 10 than a wet, or soiled, cleaning sheet 10. The cleaning tool 10 bound to cleaning sheet 40, or other cleaning material, forms a cleaning system.

Lower portion 16 may be an elongated piece of material such as plastic, metal or other material. Lower portion 16 may be a rectangular plate, block or sheet having four corners, such that the corners may be used to access hard to reach areas such as corners of windows or walls. Shapes other than rectangular are contemplated within the scope of the present disclosure. Lower portion 16 may be generally rectangular with a side-to-side width less than its front-to-back length. Adhesive sheet stack 22 and hook fastener portion 30 may be attached to lower portion 16 with an adhesive or other means of attachment, as would be known to one of ordinary skill in the art. Lower portion 16 may be attached to hand grip 12 with adhesives, screws, nails, pins, stakes, or other attachment means, which may be used to secure the lower portion 16 to hand grip 12.

The cleaning material according to the present disclosure may be of two types, where the first is a cleaning sheet capable of only binding to the adhesive, and the second being a cleaning material that will attach to a hook fastener portion 30 of a hook and loop fastener. In FIGS. 4a and 4b, the cleaning material, or cleaning sheet 40, disposed on cleaning tool 10 is a single layer of absorbent material such as a non-woven material or a paper towel-like material.

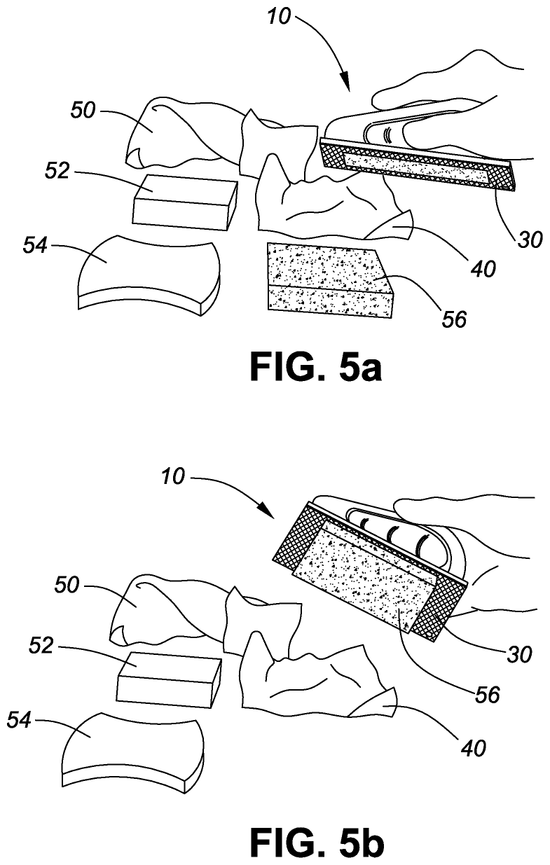

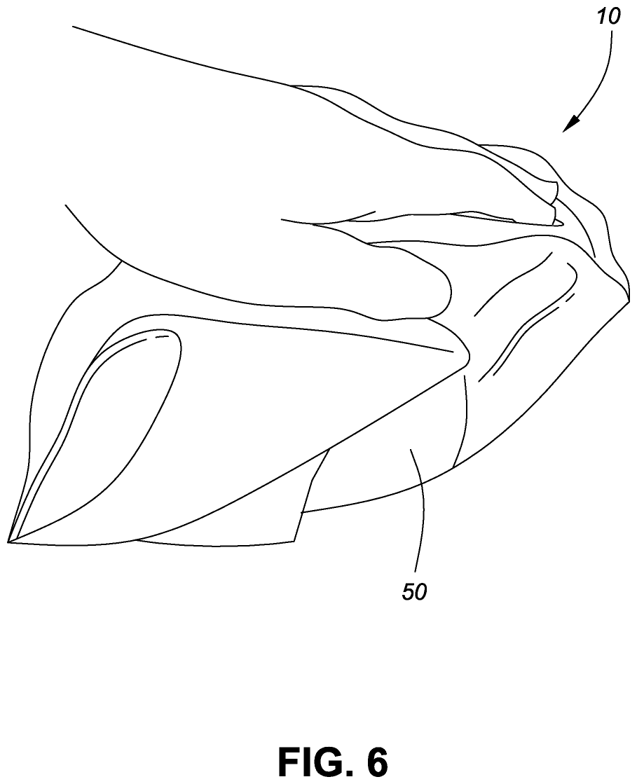

FIGS. 5a and 5b show cleaning materials including those that will attach to hook fastener portion 30, which may include sponge-like and woven materials. These cleaning materials would not effectively bind the adhesive portion of the present disclosure; however, they will attach to the cleaning tool 10 with the hook fastener portion 30. The hook fastener portion 30 may attach to a cloth 50, such as terrycloth, a microfiber block 52, a synthetic scouring pad 54 and a sponge 56, wherein the sponge 56 may be comprised of polyester, polyurethane, or vegetal cellulose. Polyurethane is used in polyester sponges for their abrasive side. Polyester sponges are more common for dish washing and are usually soft and yellow. Vegetal cellulose sponges made of wood fiber are more used for bathing and skin cleaning, and are usually tougher and more expensive than polyester sponges. The surface area of the area of hook fastening portion 30 will be sufficient to hold a wet cleaning material bound to cleaning tool 10, as shown in FIG. 5b and FIG. 6.

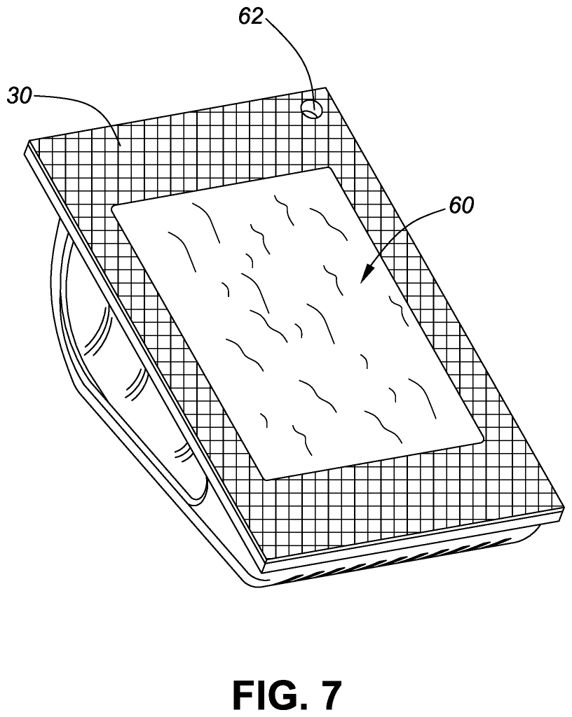

FIG. 7 shows one embodiment of the present disclosure where the adhesive portion is an adhesive gel 60 rather than an adhesive sheet. Adhesive gel 60, according to the present disclosure, would serve the same function as adhesive sheet 20. FIG. 7 also shows an aperture 62, which may be used for storing cleaning tool 10.

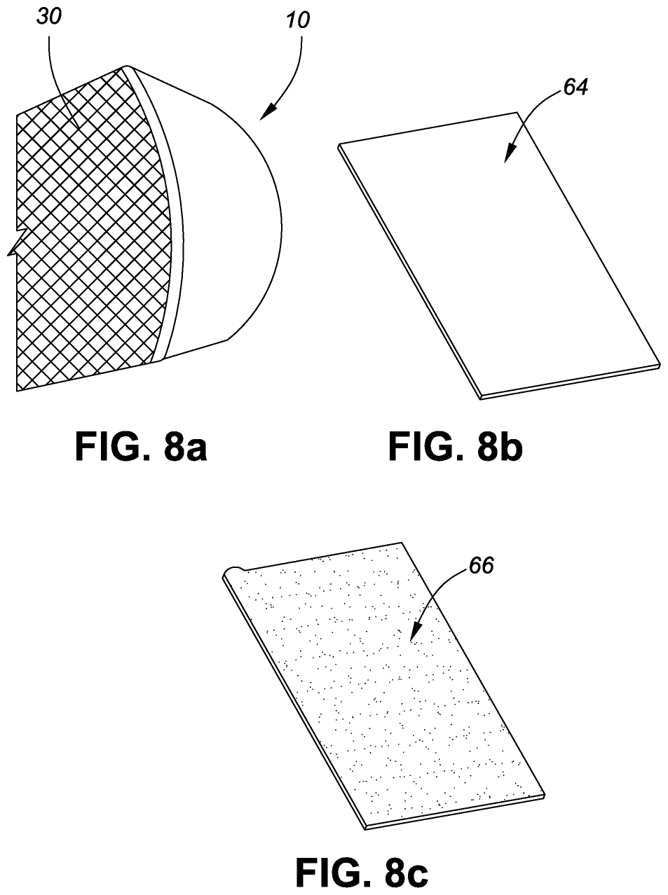

FIGS. 8a-8c shows an embodiment of the present disclosure where an adhesive sheet stack 22 has a felt side 64 and an adhesive side 66. The felt side 64 of adhesive sheet stack 22, in this embodiment, is removably attachable to a hook fastener portion 30 of cleaning tool 10.

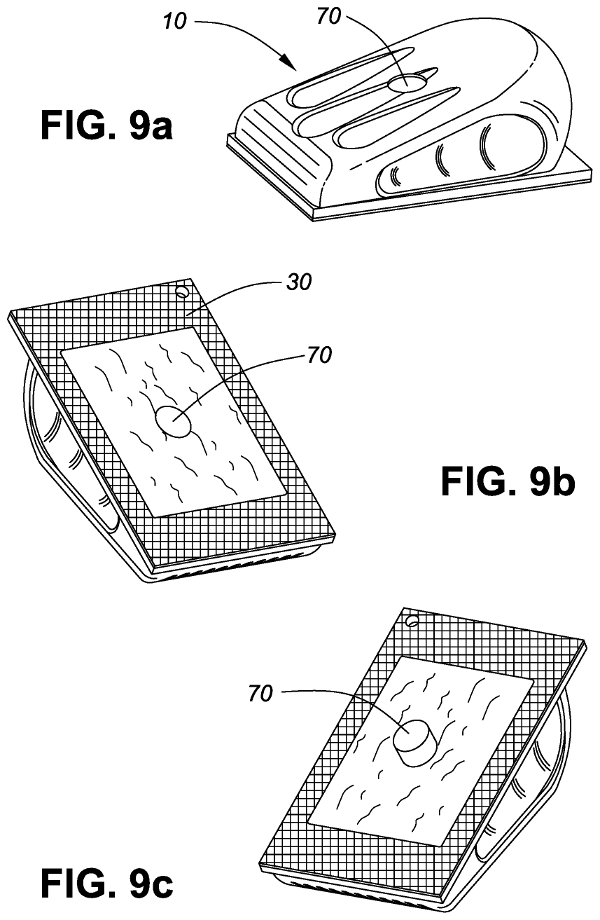

FIGS. 9a-9c show an embodiment of the present disclosure including a release mechanism 70. In one embodiment, release mechanism 70 may be positioned centrally and be adapted to be vertically adjusted through cleaning tool 10. Release mechanism 70 may be a dowel, and may be held in place by friction or other means as would be known to one of ordinary skill in the art, such that release mechanism 70 maintains a neutral position until pressed by a user. The release mechanism may comprise a dowel comprised of foam or any material that can stay rigid enough to not collapse when pressed through a channel. Spring loaded mechanisms may also be used, similar to a ball point pen device, as would be known to one of ordinary skill in the art. Release mechanism 70 in a neutral position is shown in FIGS. 9a and 9b, and once pressed by a user, release mechanism 70 will move downward and push a cleaning material away from cleaning tool 10, such that the cleaning material will separate from cleaning tool 10 without the need for a user to remove the cleaning material by hand. Release mechanism 70 may then be returned to the neutral position, in one embodiment, by pressing cleaning tool 10 on a flat surface.

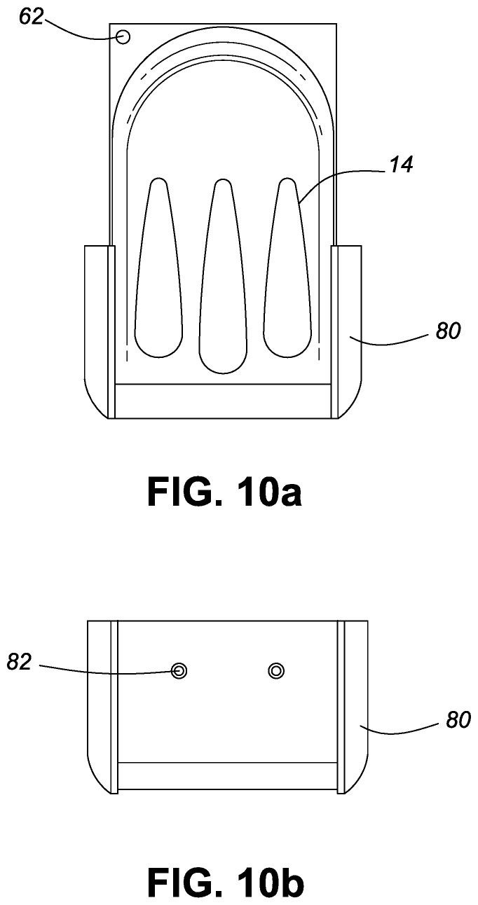

FIGS. 10a and 10b show a wall mount 80 for cleaning tool 10. Wall mount 80 may be adapted to receive cleaning tool 10 by sliding lower portion 16 of cleaning tool 10 into wall mount 80, as shown in FIG. 10a. Wall mount 80 may have two side panels and a lip or edge at a bottom side, thereby forming a sideways “C” shape. FIG. 10b shows wall mount 80 attached by screws 82 to a wall.

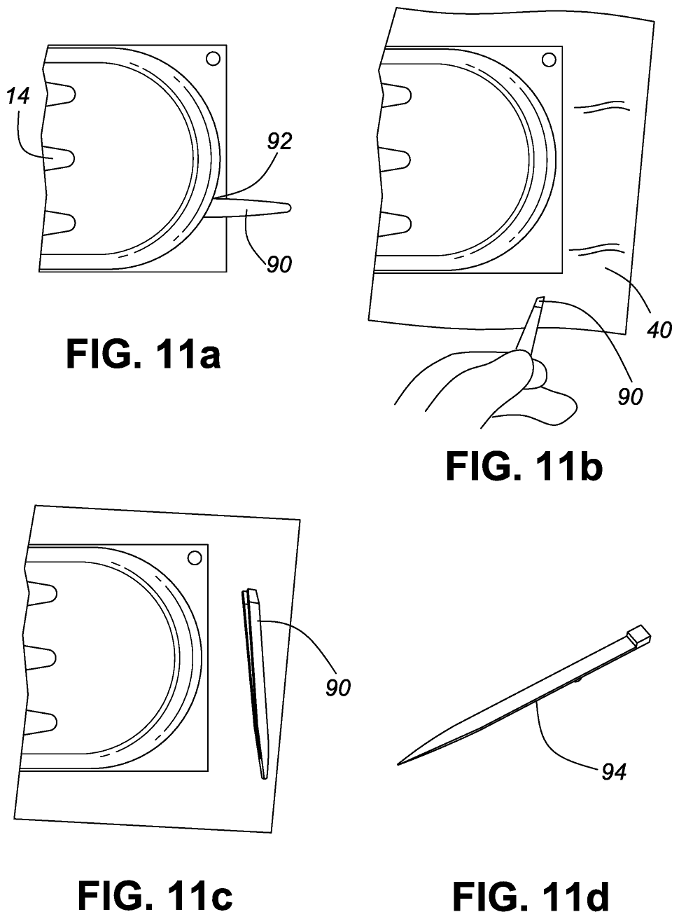

FIGS. 11a-11d show an embodiment of the present disclosure, including a removal tool 20. The removal tool 20 may be a tweezer, as shown in FIGS. 11a-c or a pick 94, as shown in FIG. 11d. FIG. 11a shows a storage port 92 for removal tool 20. Removal tool 20 may be removed from storage port 92 in order to grasp or push a cleaning material, such as a cleaning sheet 20, to remove it from cleaning tool 10.

In some embodiments, cleaning sheet 40 or other cleaning material may stay attached to the bottom of cleaning tool 10 such that it is ready for use. Additionally, if the cleaning sheet 40 is used to clean spills the cleaning sheet 40 may dry out and may be reused with the grip in place.

The aperture 62 at the back of cleaning tool 10 may be used to hang cleaning tool 10 on a hook, although other methods of storage are contemplated within the present disclosure, including by attaching cleaning tool 10 to loop sections to form a conventional hook and loop fastener attachment. A wall mounted holster or a counter top receptacle may also be used. Each storage means would allow for air flow to enable the sticky surface to dry.

Force applied to the top of cleaning tool 10 flattens the hooks while pushing the adhesive sheet 20 down in order to contact cleaning sheet 40. Such force, in this case, does not dislodge adhesive sheet stack 22 from the stack recess 24 as a pressure fit from all sides holds the adhesive sheet stack 22 in place.

Cleaning tool 10 may be comprised of a foam material such that it may compress for lower shipping costs. Cleaning tool 10, in this embodiment, would decompress when opened by a user. A smaller version of cleaning tool 10 may be utilized for areas with limited space. Scaling would be accomplished as would be known to one of ordinary skill in the art. A metal version of cleaning tool 10 could be used to clean restaurant cooking grills.

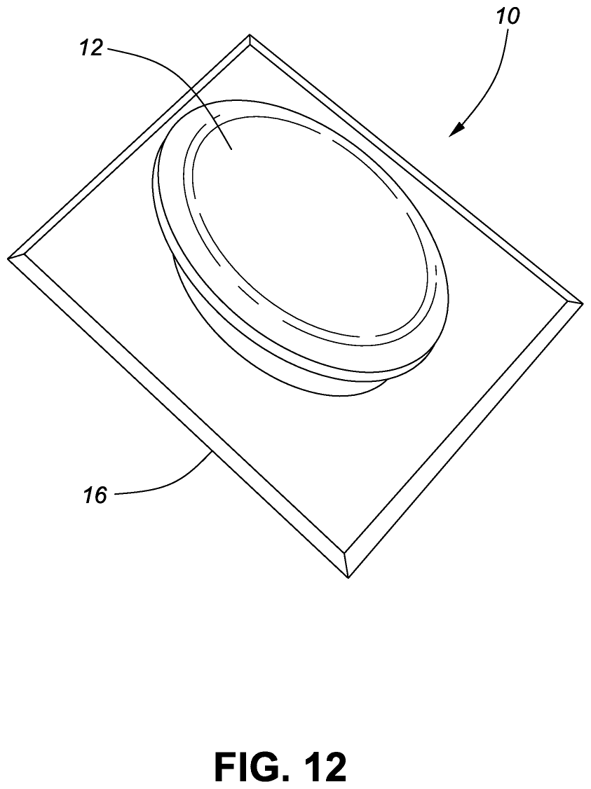

FIG. 12 shows one embodiment of cleaning tool 10, wherein cleaning tool 10 has a generally oval hand grip 12, wherein the top of hand grip 12 has a greater diameter than the bottom of the hand grip 12. The lower portion 16, in one embodiment, may be generally flat.

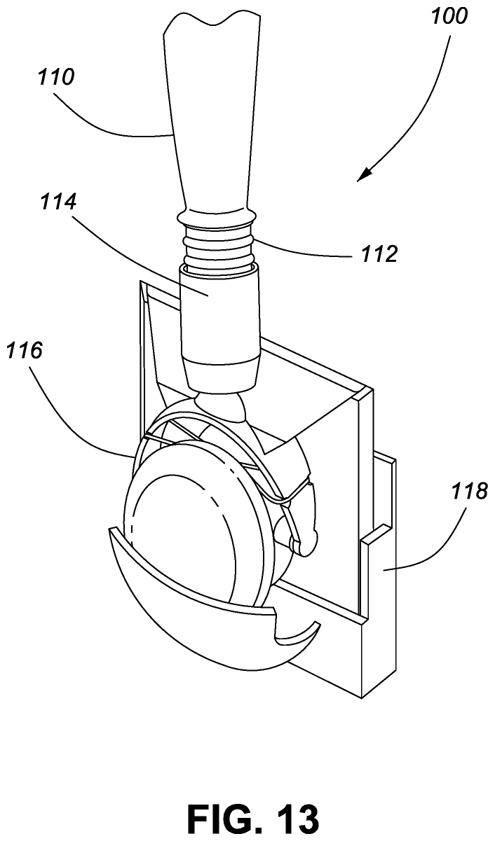

With regard to FIG. 13, handled cleaning tool 100 is disclosed. Handled cleaning tool 100 includes a handle 110 attached to cleaning tool 10. The means by which handle 110 is attached to cleaning tool 10 may be, in one embodiment, through a connection between male threaded adapter 112 and female threaded adapter 114. In one embodiment, handle 110 is telescopically extendable, as would be known to one of ordinary skill art. In one embodiment, handle 110 is connected to a rotatable forked connector 116, which is attached to cleaning tool 10. The cleaning tool 10 may be stored housing 118 between use.

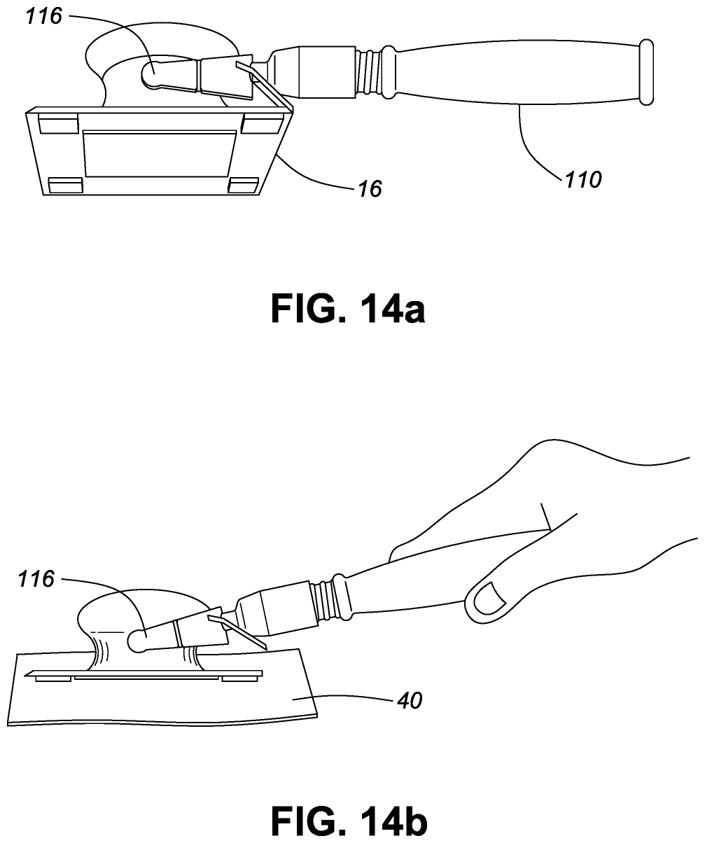

FIGS. 14a and 14b show handle 110 being lifted to rotate rotatable forked connector 116 around and above hand grip 12. FIG. 14b shows lower portion 16 adhesively attached to cleaning sheet 40.

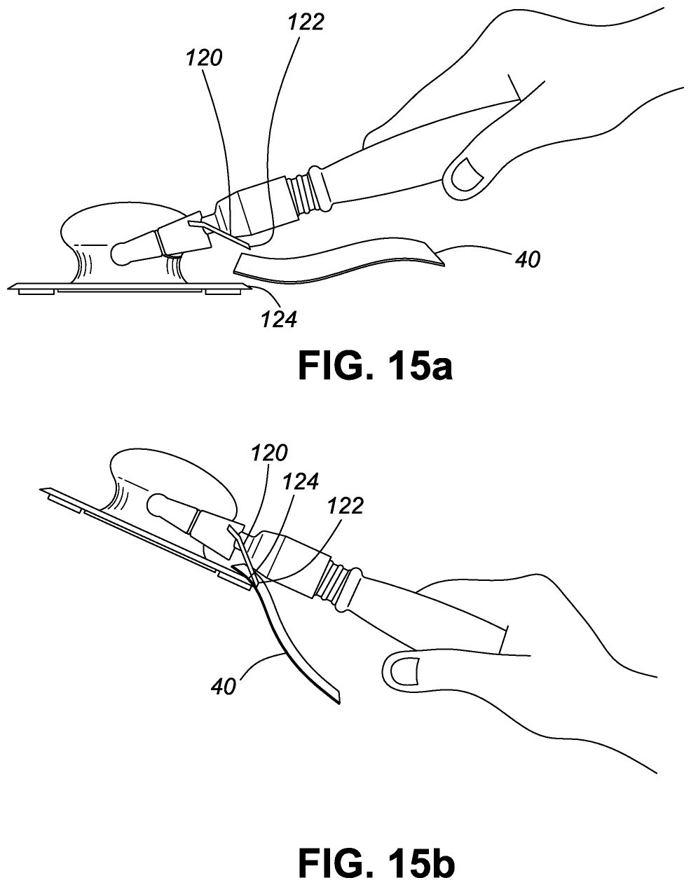

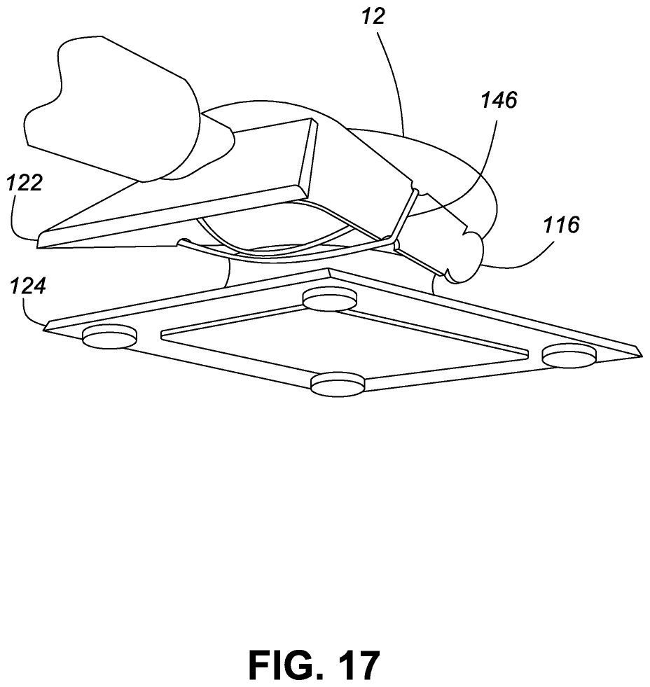

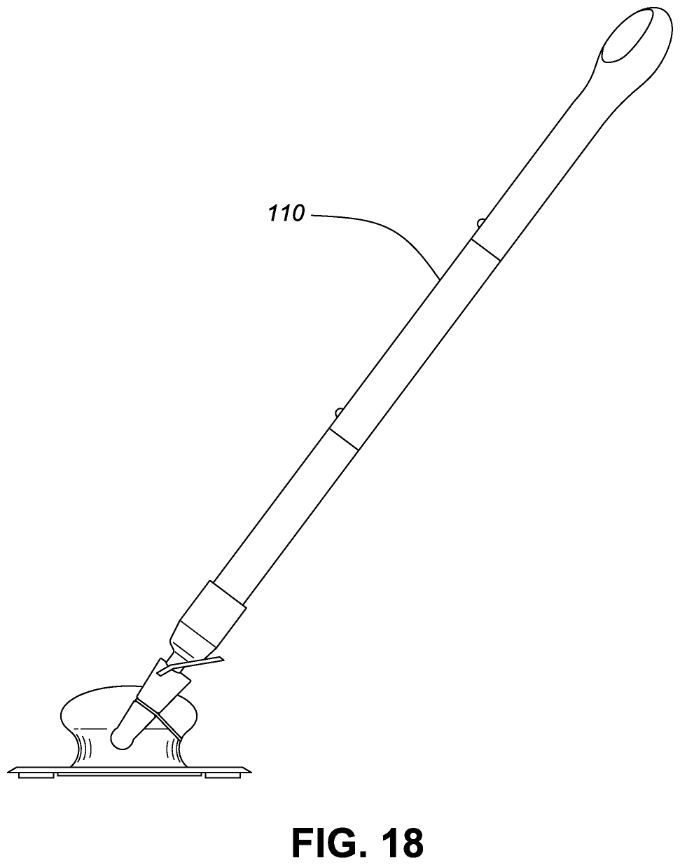

FIG. 15a shows cleaning sheet 40 being inserted into a gripping portion of handled cleaning tool 100. The gripping portion is comprised of upper gripping portion 120, upper gripping portion contact edge 122 and lower gripping portion contact edge 124. To operate the gripping portion, upper gripping portion contact edge 122 and lower gripping portion contact edge 124 are separated by rotating the rotatable forked connector 116 around and toward hand grip 12. Rotation of rotatable forked connector 116 back into its resting position provides a grip to hold a cleaning sheet 40 or other type of cleaning device in place. When used with a gripping device, in some embodiments, the adhesive will automatically release a saturated cleaning sheet, as a standard adhesive could be expected to do when saturated with a wet material, thereby allowing a user to apply the gripping portion to cleaning sheet 40 to grasp cleaning sheet 40 for disposal. The gripping portion may be opened by placing the bottom surface of the cleaning tool on a surface to be cleaned and rotating the handle forward. To dispose of cleaning sheet 40, the front of handle grip 12 may be pulled back toward the user, thereby separating upper gripping portion contact edge 122 and lower gripping portion contact edge 124, thereby releasing cleaning sheet 40. In some embodiments, hook fastener portion 30 may be located at the corners on the bottom surface of the cleaning tool 10, as shown in FIG. 17. In some embodiments, the handle may be long, as in a standard mop, so that a using can operate the device while standing, as shown in FIG. 18.

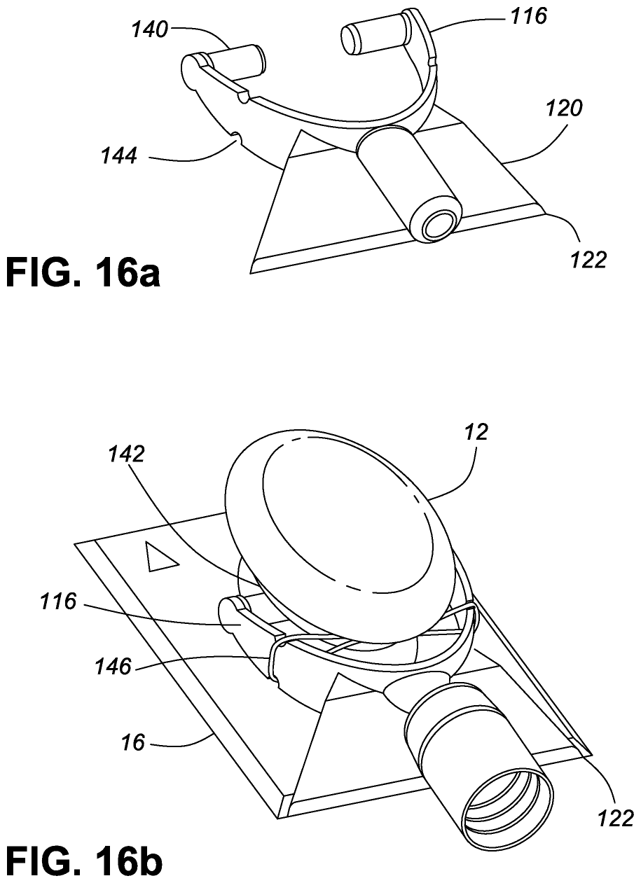

As shown in FIGS. 16a and 16b, rotatable forked connector 116 is connected to hand grip 12 of cleaning tool 10 through male cleaning tool adapter 140 and female cleaning tool adapter 142, which may be connected on adjacent sides of hand grip 12. FIG. 16a shows elastic band acceptor grooves 144, which accept elastic band 146. As rotatable forked connector is mounted on hand grip 12 through male and female cleaning adapters 140 and 142, respectively, elastic band 146, after being placed between elastic band acceptor grooves 144, is stretched to provide resistance to the rotation of cleaning tool 10.

FIG. 17 shows how elastic band 146 may stretch in the direction of handle 110 when in contact with hand grip 12. Elastic band 146 provides a force to close the gap between upper gripping portion contact edge 122 and lower gripping portion contact edge 124 and thereby grip a cleaning sheet or cleaning element.

Alternative means for connecting handle 110 to hand grip 12 are contemplated within the scope of the present invention, including a spring-operated mechanism that may replace elastic band 146, wherein springs, or at least one spring, may be mounted between handle 110 and hand grip 12 to provide force to close the gap between upper gripping portion contact edge 122, wherein an edge may also be referred to as a surface, and lower gripping portion contact edge 124, wherein an edge may also be referred to as a surface, and thereby grip a cleaning sheet or cleaning element.

In view of the teaching presented herein, other modifications and variations of the present disclosures will be readily apparent to those of skill in the art. The foregoing drawings, discussion, and description are illustrated of some embodiments of the present invention, but are not meant to be limitations on the practice thereof. It is the following claims, including all equivalents, which define the scope of the invention.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

What is claimed is:

1. A system for cleaning, comprising:
a cleaning tool having a hand grip;
a lower portion affixed to the hand grip, wherein the lower portion is a flat surface;
an adhesive portion affixed to the lower portion, whereby the adhesive portion forms a flat surface;
wherein an adhesive is exposed on the adhesive portion;
a rotatable forked connector attached to the hand grip;
wherein the rotatable forked connector is attached to an elongate handle.

2. The system for cleaning of claim 1, wherein the elongate handle is attached to the rotatable forked connector by a male-female threaded adapter.

3. The system for cleaning of claim 1, wherein a connection between the hand grip and the rotatable forked connector is through a first male-female cleaning tool adapter and a second male-female cleaning tool adapter, wherein the first male-female cleaning tool adapter and the second male-female cleaning tool adapter are situated on opposite sides of the hand grip.

4. The system for cleaning of claim 1, wherein the rotatable forked connector includes an upper gripping surface situated below the handle and wherein the lower portion of the cleaning tool includes a lower gripping surface for grasping a cleaning sheet between the upper gripping surface and the lower gripping surface.

5. The system for cleaning of claim 4, wherein the rotatable forked connector is attached to an elastic band; wherein the rotatable forked connector includes elastic band grooves for securing the elastic band; wherein the elastic band is in contact with a rear portion of the hand grip when the hand grip is secured to the forked connector, such that a rotational force is applied to the hand grip by the elastic band when the handle is rotated forward with respect to the hand grip.

6. The system for cleaning of claim 1, wherein at least one spring is mounted between handle and the hand grip to provide a force to close the gap between an upper gripping surface and a lower gripping surface and thereby grip a cleaning sheet or cleaning element.

7. The system for cleaning of claim 1, further comprising a cleaning sheet removably bound to the adhesive portion.

8. A system for cleaning, comprising:
a cleaning tool having a hand grip;
a lower portion affixed to the hand grip, wherein the lower portion is a flat surface;
an adhesive portion affixed to the lower portion, whereby the adhesive portion forms a flat surface;
wherein an adhesive is exposed on the adhesive portion;
a rotatable connector attached to the hand grip;
wherein the rotatable connector is attached to an elongate handle.

9. The system for cleaning of claim 8, wherein the rotatable connector is a rotatable forked connector.

10. The system for cleaning of claim 9, wherein the elongate handle is attached to the rotatable forked connector by a male-female threaded adapter.

11. The system for cleaning of claim 10, wherein a connection between the hand grip and the rotatable forked connector is through a first male-female cleaning tool adapter and a second male-female cleaning tool adapter, wherein the first male-female cleaning tool adapter and the second male-female cleaning tool adapter are situated on opposite sides of the hand grip.

12. The system for cleaning of claim 11, wherein the rotatable forked connector includes an upper gripping surface situated below the handle and wherein a lower portion of the cleaning tool includes a lower gripping surface for grasping a cleaning sheet between the upper gripping surface and the lower gripping surface.

13. The system for cleaning of claim 12, wherein the rotatable forked connector is attached to an elastic band; wherein the rotatable forked connector includes elastic band grooves for securing the elastic band; wherein the elastic band is in contact with a rear portion of the hand grip when the hand grip is secured to the forked connector, such that a rotational force is applied to the hand grip by the elastic band when the handle is rotated forward with respect to the hand grip.

14. The system for cleaning of claim 8, wherein at least one spring is mounted between handle and the hand grip to provide force to close the gap between upper gripping portion contact edge and lower gripping portion contact edge and thereby grip a cleaning sheet or cleaning element.

15. The system for cleaning of claim 8, further comprising a cleaning sheet removably bound to the adhesive portion.

16. The system for cleaning of claim 8, wherein the adhesive portion is a reusable dry adhesive.

17. A system for cleaning, comprising:
a cleaning tool having a hand grip;
a lower portion affixed to the hand grip, wherein the lower portion is a flat surface;
an adhesive portion affixed to the lower portion, whereby the adhesive portion forms a flat surface;
wherein the adhesive portion is comprised of a reusable dry adhesive;
a rotatable forked connector attached to the hand grip;
wherein the rotatable connector is attached to an elongate handle;
wherein the elongate handle is attached to the rotatable forked connector by a male-female threaded adapter;
wherein a connection between the hand grip and the rotatable forked connector is through a first male-female cleaning tool adapter and a second male-female cleaning tool adapter,
wherein the first male-female cleaning tool adapter and the second male-female cleaning tool adapter are situated on opposite sides of the hand grip;
wherein the rotatable forked connector includes an upper gripping surface situated below the handle and wherein a lower portion of the cleaning tool includes a lower gripping surface for grasping a cleaning sheet between the upper gripping surface and the lower gripping surface.

18. The system for cleaning of claim 18, wherein the rotatable forked connector is attached to an elastic band; wherein the rotatable forked connector includes elastic band grooves for securing the elastic band; wherein the elastic band is in contact with a rear portion of the hand grip when the hand grip is secured to the forked connector, such that a rotational force is applied to the hand grip by the elastic band when the handle is rotated with respect to the hand grip.

19. The system for cleaning of claim 16, wherein at least one spring is mounted between handle and the hand grip to provide force to close the gap between an upper gripping portion contact edge and a lower gripping portion contact edge and thereby grasp a cleaning sheet or cleaning element.

20. The system for cleaning of claim 18, wherein a resilient material is situated between the handle and the hand grip, such that a forward rotational force applied to the handle is met with resistance by the resilient material to resist, but not stop, rotation of the handle with respect to the hand grip.
